(19) United States
(12) Patent Application Publication
(10) Pub. No.: US 2007/0271263 A1
(43) Pub. Date: Nov. 22, 2007

(54) Displaying Data

(75) Inventor: Ulrik Merrild, Tampa, FL (US)

Correspondence Address: BANNER & WITCOFF, LTD., 1100 13th STREET, N.W., SUITE 1200, WASHINGTON, DC, 20005-4051, US

(73) Assignee: MATCHWARE A/S, Aarhus C (DK)

(21) Appl. No.: 11/419,369

(22) Filed: May 19, 2006

(51) Int. Cl. G06F 17/30

(52) U.S. Cl. 707/6

(57) ABSTRACT

There is provided a method of displaying data including data items, the method including: creating a first visual presentation format for the data, wherein the first format is a non-linear hierarchical format formed by a nodal tree structure including nodes each associated with a hierarchy, with a central node and sub-nodes branching off from the central node or from a respective sub-node of a higher hierarchy, wherein each node represents one of the data items, and at least some of the data items are associated with numerical information; creating a second visual presentation format for the data, wherein the data items are arranged along a scale in accordance with the numerical information associated with at least some of the data items; and displaying the data in the first or second format.

### FIELD

This invention relates to a method and computer system for selectively displaying data in a first, non-linear hierarchical format or a second, linear non-hierarchical format.

### BACKGROUND

Systems and methods are known to graphically illustrate information in the form of a visual hierarchy in an electronic workspace, in particular the screen of a computer. An example of such system and method is described in EP-A-1615145.

The hierarchical representation of information is referred to as a mind map. That is, a mind map is a visual illustration of information in a non-linear hierarchical format. The non-linear format comprises a nodal tree structure with a central parent node and sub-nodes or branches extending from the parent node.

Although a mind map generally has several advantages compared to conventional representations of information, its visual structure does not reflect the information content of any of the nodes or branches. However, in some situations, it may be desirable to rearrange the visual structure in accordance with the values of a given parameter contained in the visualised information.

### SUMMARY OF THE INVENTION

According to an aspect of the invention, there is provided a method of displaying data comprising a plurality of data items, the method comprising: creating a first visual presentation format for the data, wherein the first format is a non-linear hierarchical format formed by a nodal tree structure comprising a plurality of nodes each associated with one of a plurality of hierarchies, with a central node and a plurality of sub-nodes branching off from the central node or from a respective sub-node of a higher hierarchy, wherein each node represents one of the plurality of data items, and at least some of the data items are associated with numerical information; creating a second visual presentation format for the data, wherein the data items are arranged along a scale in accordance with the numerical information associated with at least some of the data items; and displaying the data in the first or second format.

Aspects of the invention reside in the idea of using numerical information that may be associated with the data items of a mind map to provide an alternative, second display format. The second display format reflects the information content of the data items. Accordingly, the user may select and switch between two alternative formats to better display and understand the information contained in the data items of the mind map.

In the second display format, the data items may be arranged along the scale in linear order. Alternatively, the user may select a non-linear (for example exponential) scale.

In one embodiment of the invention, the numerical information is time information, and the scale is formed by a time line. In this embodiment, the data items may be arranged along the time line in chronological order.

According to an illustrative feature, in the second format, only data items associated with a selected one of the plurality of hierarchies are arranged along the scale or time line. Thereby, the amount of displayed information may be reduced to better understand selected information. However, information relating to data items of hierarchies other than the selected hierarchy may optionally be displayed in a window in a hierarchical fashion (as will be explained in more detail in connection with the drawings).

### BRIEF DESCRIPTION OF THE DRAWINGS

Embodiments of the invention will now be described, by way of example only, with reference to the accompanying drawings, in which:

FIG. 1 is an example of a mind map in which data is displayed in a non-linear hierarchical fashion;

FIG. 2 is an example of a flat time line view in which data associated with time information is displayed in a linear chronological order along a time line;

FIG. 3 is an example of a level time line view in which data associated with time information of one selected hierarchy is displayed in a linear chronological order along a time line;

FIG. 4 is an example of a level time line view in which data relating to a hierarchy other than the selected hierarchy is additionally displayed in a hierarchical fashion in a window; and

FIG. 5 is a flowchart illustrating the steps which are performed to convert a non-linear hierarchical display (mind map view) into a linear non-hierarchical display (time line view).

### DETAILED DESCRIPTION

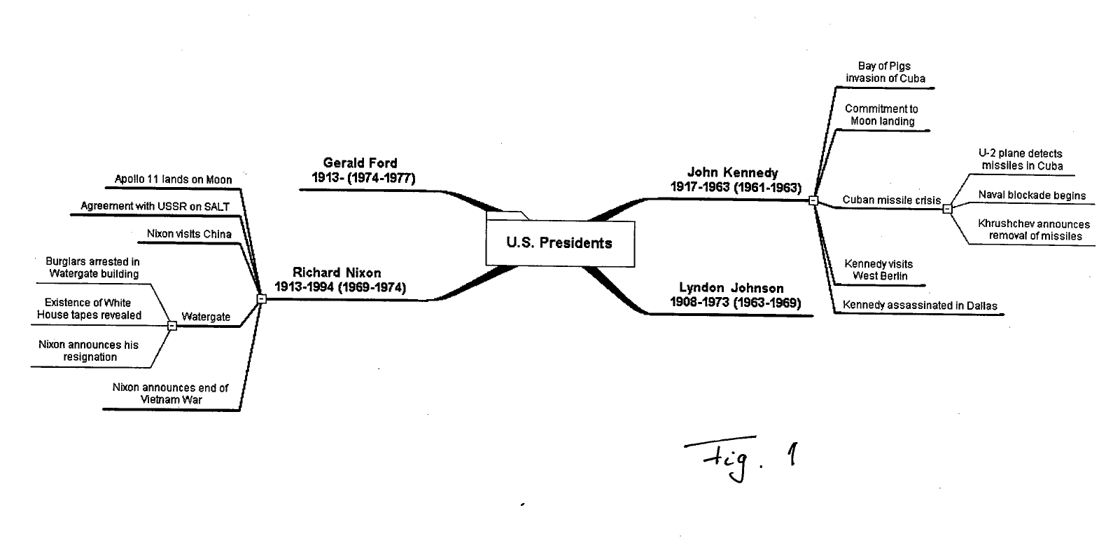

An example of a mind map is illustrated in FIG. 1. Compared to linear non-hierarchical representations of information, a mind map has a “natural” organisational structure that radiates from the centre and uses lines, symbols, words, colour and images according to simple, “brain-friendly” concepts. In other words, a mind map may be used to convert a long list of monotonous information into a colourful, memorable and organized diagram that may be understood a memorised more easily.

A mind map may be compared with the map of a city. The city centre represents the main idea; the main roads leading from the centre represent the key thoughts in a thinking process; the secondary roads or branches represent secondary thoughts, and so on. Special images or shapes can represent landmarks of interest or particularly relevant ideas.

The essential characteristics of a mind map can be summarised as follows:
The main idea, subject or focus forms a central image.
The main themes radiate from the central image as ‘branches’.
The branches comprise a key image or key word drawn or printed on its associated line.
Topics of lesser importance are represented as ‘twigs’ of the relevant branch.
The branches form a connected nodal structure.

FIG. 1 shows an example of a mind map to illustrate historical information. In particular, the mind map of FIG. 1 shows the US presidents between 1961 and 1977 and selected historical events within that period.

The central node is formed by the subject of the mind map, i.e. “US presidents”. The nodes branching off from the central node form sub-nodes of the first hierarchy and contain the names of the US presidents between 1961 and 1977. The nodes branching off from the sub-nodes of the first hierarchy form sub-nodes of the second hierarchy and represent information on selected historical events, e.g. Nixon's visit to China, Watergate, the Bay of Pigs invasion of Cuba, and the Cuba missile crisis. Some of these sub-nodes are terminal nodes, i.e. nodes from which no further sub-nodes of a lower hierarchy branch off (e.g. the nodes representing Nixon's visit to China, and the Bay of Pigs invasion of Cuba). From other of the sub-nodes of the second hierarchy, further nodes branch off, forming sub-nodes of the third hierarchy. The nodes of the third hierarchy represent information on specific historical events during the Watergate affair and the Cuba missile crisis.

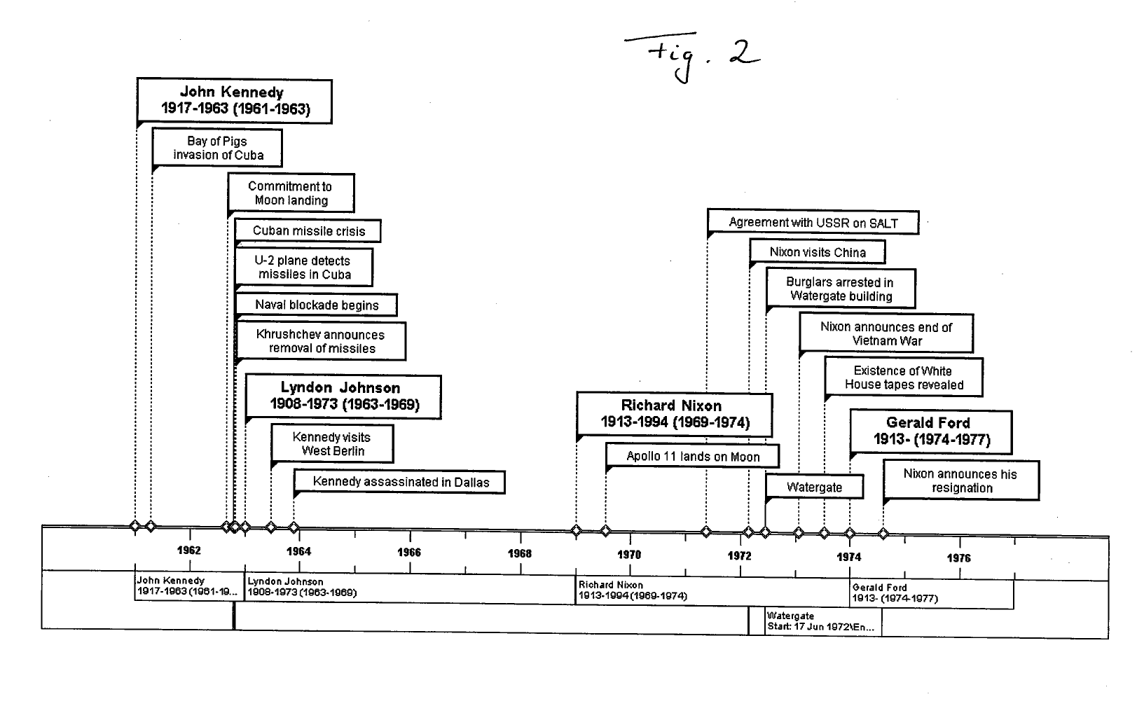

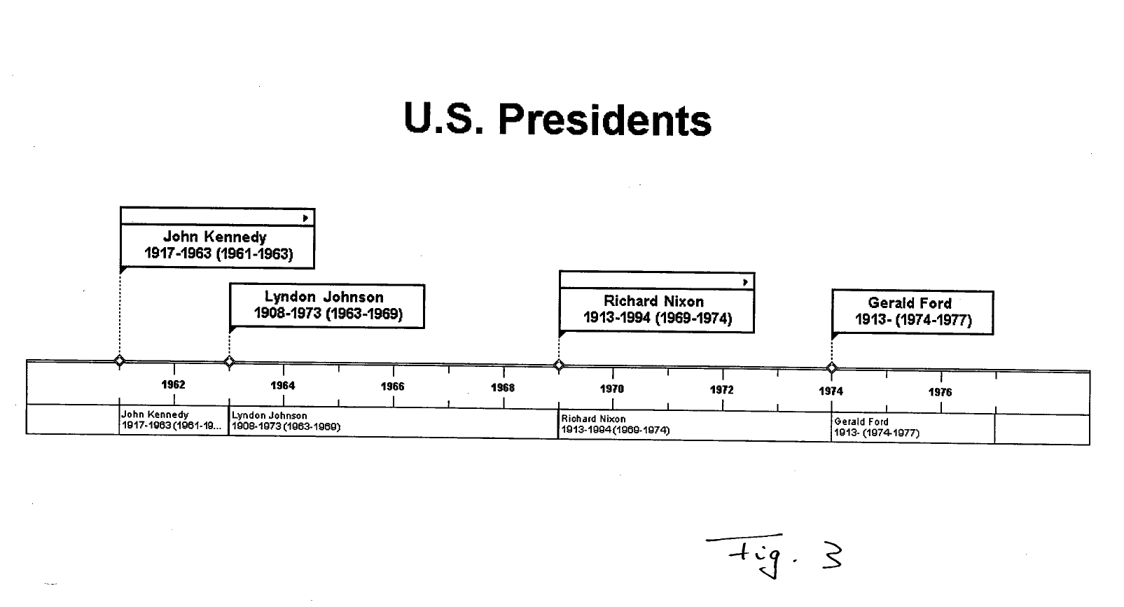

The format illustrated in FIG. 1 is a first, non-linear hierarchical visual presentation format based on a nodal tree structure. The first format is referred to as mind map view. According to a method embodying the present invention, the first format can be converted into a second visual presentation format in which information is displayed in chronological order along a time line. The second format is referred to as time line view. FIGS. 2 and 3 illustrate examples of time line views of the historical information of FIG. 1 after conversion into the second format.

Generally, the time line view displays all the branches of the mind map that contain time information in chronological order along a horizontal time axis. If a particular event is associated with both a start time and an end time, the duration of this event is shown as a bar below the time axis.

The time line view shows all the branches of the mind map, including those that do not contain time information. The time line itself, however, only shows the branches containing time information.

According to illustrative features, the time line scale can be zoomed in or out, expanded or contracted, and empty stretches of the time line can be condensed by inserting break marks. Parts of the data can be displayed in more detail by applying filtering to view a particular branch. Different timescales are available in order to represent a variety of different events, such as the planning of a product launch, the life cycle of a bee or the rise and fall of an ancient civilization.

By default, the time line is shown in a flat display, meaning that all the branches and sub-branches that contain time information are represented, regardless of the hierarchical structure of the mind map. FIG. 2 illustrates an example of a flat display time line view applied to the information of the mind map of FIG. 1. The flat display is well suited to time lines which do not have many levels of branches and sub-branches.

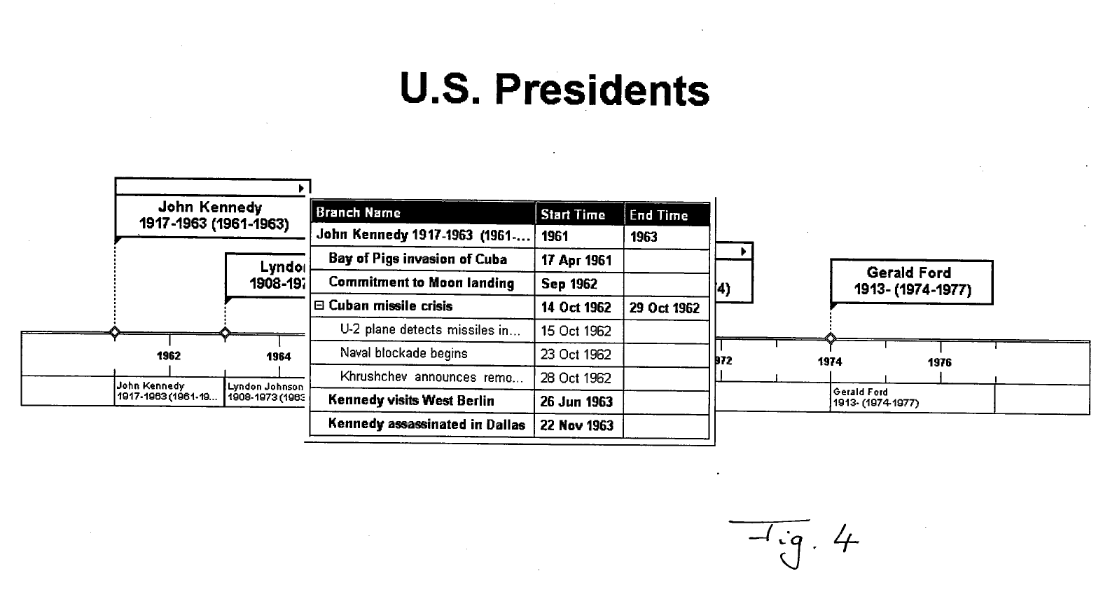

FIG. 3 illustrates an alternative mode referred to as level display. The level display is a structured display that permits the display of one level of branches in more detail—one level at a time—while accessing the sub-branches through drop-down hierarchical lists. For example, the timeline only shows the main branches of the mind map. Main branches that do not contain time information are not represented. Main branches that contain sub-branches are identified by an arrow icon on their top right. Clicking this arrow opens a hierarchical list providing access to all the sub-branches of the branch in question, including those that have no time information. This is illustrated in FIG. 4.

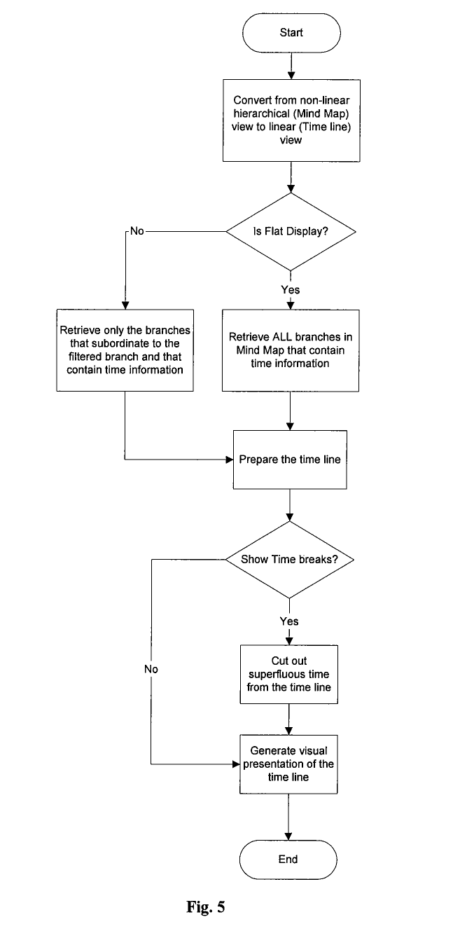

FIG. 5 is a flowchart illustrating the steps which are performed to convert a mind map view into a time line view, including the setting of time breaks (optionally).

It will be clear from the foregoing that the above-described embodiments are only examples, and that other embodiments are possible and included within the scope of the invention as determined from the claims.

1. A method of displaying data comprising a plurality of data items, the method comprising:
creating a first visual presentation format for the data, wherein the first format is a non-linear hierarchical format formed by a nodal tree structure comprising a plurality of nodes each associated with one of a plurality of hierarchies, with a central node and a plurality of sub-nodes branching off from the central node or from a respective sub-node of a higher hierarchy, wherein each node represents one of the plurality of data items, and at least some of the data items are associated with numerical information;
creating a second visual presentation format for the data, wherein the data items are arranged along a scale in accordance with the numerical information associated with at least some of the data items; and
displaying the data in the first or second format.

2. The method of claim 1, further comprising converting the first format into the second format.

3. The method of claim 1, wherein, in the second format, the data items are arranged along the scale in linear order.

4. The method of claim 1, wherein the scale has user definable parameters, including the resolution of the scale and/or units associated therewith.

5. The method of claim 1, wherein the numerical information comprises time information, and the scale is formed by a time line.

6. The method of claim 5 wherein, in the second format, the data items are arranged along the time line in chronological order

7. The method of claim 5, wherein the time information comprises a start date and an end date, wherein the start date and the end date are displayed along the time line.

8. The method of claim 5, wherein the time information comprises a duration, wherein the duration is displayed along the time line.

9. The method of claim 1, wherein, in the second format, only data items associated with a selected one of the plurality of hierarchies are arranged along the scale.

10. The method of claim 9, wherein each data item of the selected hierarchy which is associated with a node from which one or more sub-nodes branch off comprises a user-operable icon, wherein, upon operation of the icon by the user, the data items associated with said one or more sub-nodes are displayed.

11. The method of claim 10, wherein the data items associated with said one or more sub-nodes are displayed in a window in a hierarchical fashion.

12. The method of claim 1, wherein, in the second format, one or more selected portions of the scale along which no data items are arranged are omitted or condensed.

13. A computer program product comprising code which, when executed by a computer, performs the method of claim 1.

14. A computer system arranged to perform the method of claim 1.

15. A computer system for displaying data comprising a plurality of data items, the system comprising:
first data formatting means for creating a first visual presentation format for the data, wherein the first format is a non-linear hierarchical format formed by a nodal tree structure comprising a plurality of nodes each associated with one of a plurality of hierarchies, with a central node and a plurality of sub-nodes branching off from the central node or from a respective sub-node of a higher hierarchy, wherein each node represents one of the plurality of data items, and at least some of the data items are associated with numerical information;
second data formatting means for creating a second visual presentation format for the data, wherein the data items are arranged along a scale in accordance with the numerical information associated with at least some of the data items; and
outputting means for outputting the data for display in the first or second format.

16. The system of claim 15, further comprising converting means for converting the first format into the second format.
